(19) United States
(12) Patent Application Publication
(10) Pub. No.: US 2026/0259818 A1
(43) Pub. Date: Sep. 3, 2026

(54) MICROSERVICE BUG TRACING

(71) Applicant: NCR Voyix Corporation, Atlanta, GA (US)

(72) Inventors: Duncan McDonald Hedden, Newnan, GA (US); William Sirotkin, Roswell, GA (US)

(21) Appl. No.: 19/067,284

(22) Filed: Feb. 28, 2025

(51) Int. Cl. G06F 11/362; G06F 11/3668

(52) U.S. Cl. CPC G06F 11/3624; G06F 11/3692

(57) ABSTRACT

Methods and system for tracking and identifying errors in distributed software systems utilizing commit hashes to trace and debug issues in retail-specific microservice architectures. Each software source code change is processed through automated testing frameworks when commits are merged into a main development branch. A centralized repository tracks changes sequentially, testing each modification against predefined validation criteria. Detailed records are maintained including version information, commit timestamps, and unique identifiers for each code change. When errors are detected, precise identification of the specific commit that introduced the issue is achieved by analyzing the sequential testing results and previous code commits. This enables rapid error identification and resolution in complex distributed systems.

### BACKGROUND

Software development, particularly in distributed microservice architectures, faces significant challenges in identifying and resolving errors efficiently. Engineers spend considerable time debugging code rather than writing new features, with studies showing worldwide software engineering debugging costs reaching approximately $1 trillion. In systems utilizing microservices, tracking the source of errors becomes exponentially more complex due to multiple potential points of failure across different services. Traditional testing frameworks often miss granular changes when not provided incremental updates, leading to cascading issues that become increasingly difficult to isolate and resolve.

### BRIEF DESCRIPTION OF THE DRAWINGS

FIG. 1A is a diagram of a system for microservice bug tracing, according to an example embodiment.

FIG. 1B is a diagram illustrating sample microservice code changes made in a central repository, according to an embodiment.

FIG. 1C is a diagram illustrating a queue for executing testing on sample committed code changes to the central repository, according to an example embodiment.

FIG. 1D is a diagram illustrating specific committed code changes that first failed testing, according to an example embodiment.

FIG. 1E is a diagram illustrating a last committed change for a microservice that passed testing before a breaking change was detected for the microservice, according to an example embodiment.

FIG. 1F is a diagram illustrating a last known status of commits as housed in the central repository, according to an example embodiment.

FIG. 2 is a flow diagram of a method for microservice bug tracing, according to an example embodiment.

FIG. 3 is a flow diagram of another method for microservice bug tracing, according to an example embodiment.

### DETAILED DESCRIPTION

In distributed software systems utilizing microservice architectures, developers face significant challenges in maintaining code quality and quickly resolving issues across multiple services. A particular challenge arises when multiple sources of potential issues make tracking down the root cause of bugs increasingly difficult. Traditional approaches using umbrella charts for tracking repository changes provide multiple service updates simultaneously, making it challenging to identify specific code changes that may have introduced problems into the microservices.

The complexity is further amplified in large teams employing continuous integration and automated testing methodologies. When changes are introduced across multiple services simultaneously, developers struggle to pinpoint exactly which modification caused a system failure or introduced unexpected behavior. This leads to engineers spending a disproportionate amount of time debugging code rather than developing new features, resulting in decreased productivity and increased development costs.

Tracing bugs in code updates presents specific technical problems in connection with microservice architectures. The technical problems include: (1) inability to track granular changes when testing frameworks receive bulk updates rather than incremental changes, (2) difficulty in identifying the precise source of breaking changes across interconnected microservices, and (3) challenges in determining the last known working state of each microservice when issues arise. These technical challenges are particularly acute in retail systems where multiple critical services like authentication, payment processing, loyalty programs, and transaction handling must maintain perfect synchronization.

Embodiments of the technology disclosed herein provide a technical solution to these technical problems through a specialized bug tracing system. In particular, the technology implements a centralized tracking system that processes individual code changes sequentially using unique Git commit hashes, enabling precise identification of when and where issues are introduced. The system maintains a queue of commits, testing each modification individually against automated validation criteria, and tracking results with detailed metadata including version information, timestamps, and commit identifiers. This represents a technological solution that improves the functioning of microservice architectures by enabling developers to pinpoint exactly which commit introduced breaking changes and quickly revert to the last known working state of any service.

In an embodiment herein, a centralized system tracks changes to microservices using Git commit hashes to precisely identify when issues are introduced. The methods and systems process each code modification through automated testing frameworks when commits are merged into a main development branch, ensuring that every push request is validated against end-to-end testing criteria.

The methods and system utilize a centralized repository that functions similar to an umbrella chart tracking repository, but instead processes individual changes sequentially as they are merged into the main branch. Each commit generates a unique hash that serves as an identifier for the specific code modifications. When these changes are tested against the automated testing framework, the results are stored with detailed metadata including version information, date, time, and the specific hash.

This systematic approach enables developers to precisely identify the last known working state of their codebase and pinpoint exactly which commit introduced breaking changes or bugs. The methods and system maintain a queue of commits, testing each modification individually and tracking the results, which provides developers with granular visibility into how their changes affect the overall system.

In an embodiment herein, a centralized system tracks changes to microservices using Git commit hashes to precisely identify when issues are introduced. The methods and system process each code modification through automated testing frameworks when commits are merged into a main development branch, ensuring that every push request is validated against end-to-end testing criteria. The system particularly focuses on retail-specific microservices, including authentication, payment, loyalty, transaction processing, and fraud detection services.

When breaking changes are detected, the methods and system can automatically notify the relevant developers through messaging platforms. The notifications provide detailed information about the problematic commit including its unique hash, version number, and description of the changes.

The methods and systems handle concurrent commits through unique hash assignments, ensuring that multiple developers can work simultaneously without losing track of individual changes. Each commit is processed through predefined pipelines of tests that are specifically customized for retail microservices, allowing for comprehensive validation of changes across the entire system.

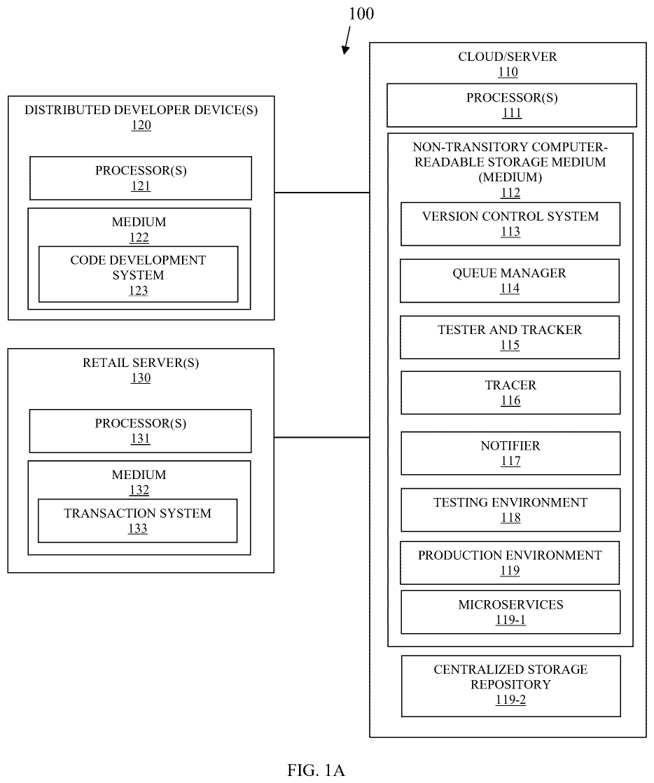

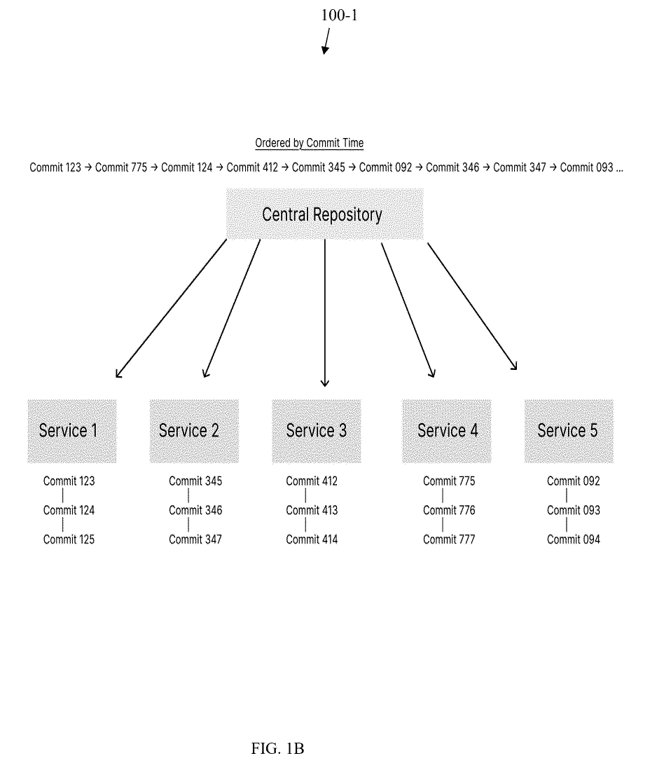

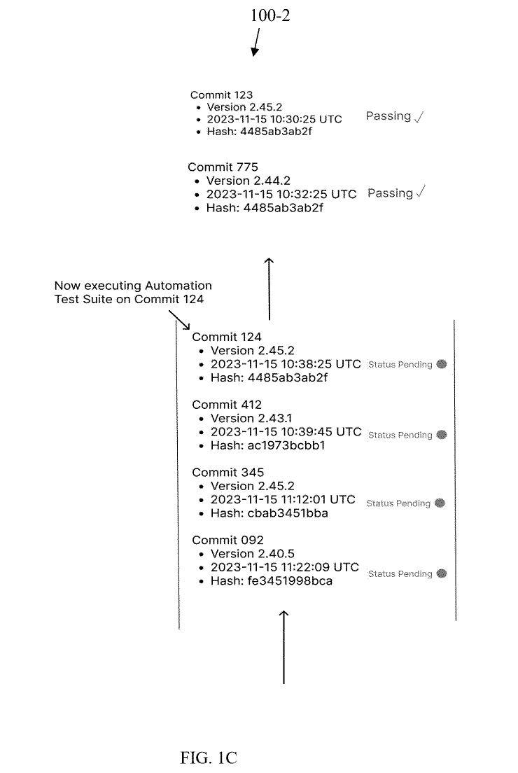

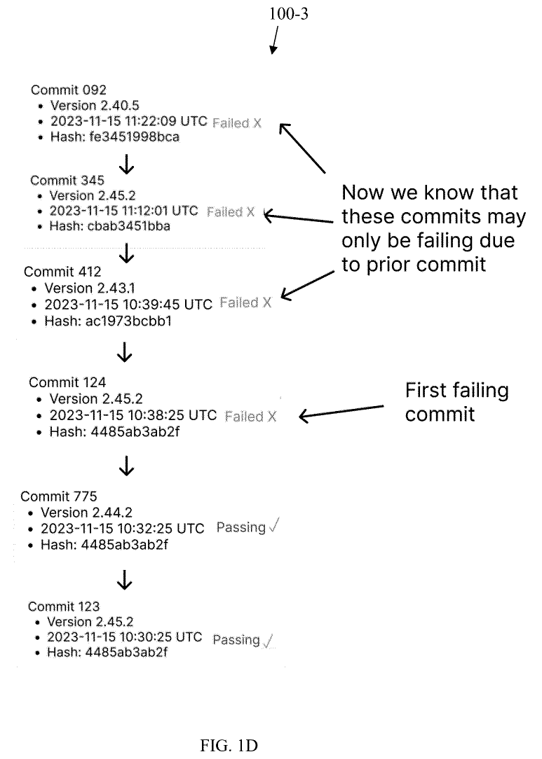

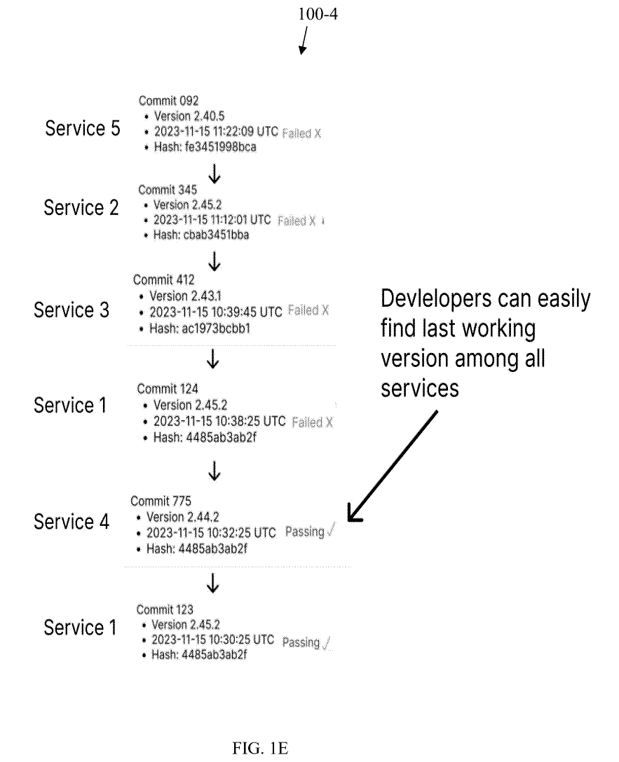

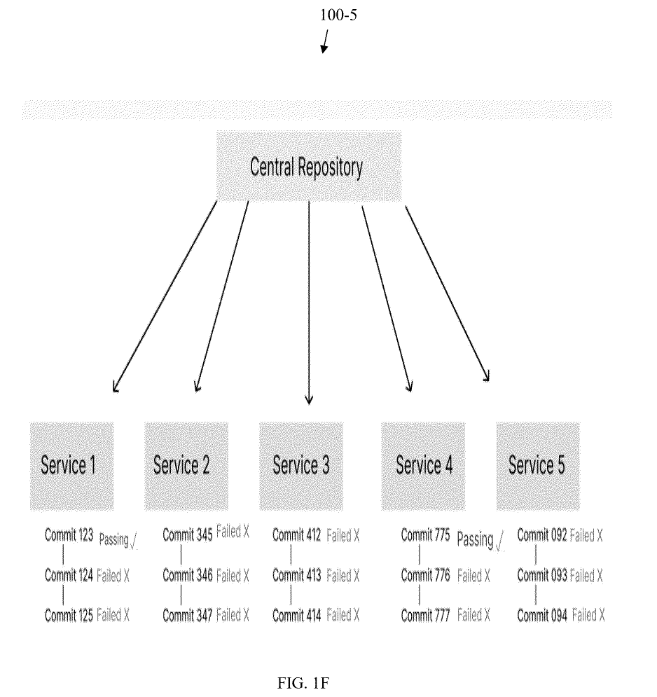

FIG. 1A illustrates a system 100 for microservice bug tracing that includes a cloud 110 or server with processors 111 and non-transitory computer-readable storage medium 112. The system 100 includes distributed developer devices 120 with processors 121, medium 122, and code development system 123. The cloud 110 implements a queue manager 114, tester and tracker 115, tracer 116, and notifier 117. The system 100 further includes a testing environment 118 and production environment 119 with microservices 119-1 and centralized storage repository 119-2. The system 100 also includes retail servers 130 with processors 131, medium 132, and transaction system 133 that utilize the production-released microservices 119-1.

Performance metrics are analyzed with every commit, enabling early detection of potential issues before they impact the production environment 119. The system 100 maintains detailed commit information including descriptive messages about changes and links to previous commits, providing a comprehensive audit trail of modifications to the codebase.

More particularly, system 100 provides microservice bug tracing, according to an example embodiment. Notably, the components are shown schematically in greatly simplified form, with only those components relevant to understanding of the embodiments being illustrated.

Furthermore, the various components (that are identified in system 100) are illustrated and the arrangement of the components are presented for purposes of illustration only. It is to be noted that other arrangements with more or less components are possible without departing from the teachings of microservice bug tracing, presented herein and below.

System 100 includes cloud 110 or server, one or more distributed developer devices 120, and one or more retail servers 130. Cloud 110 includes at least one processor 111 and a non-transitory computer-readable storage medium 112 (medium), which includes instructions for a version control system 113, a queue manager 114, a tester and tracker 115, a tracer 116, a notifier 117, a testing environment 118, a production environment 119, and microservices 119-1. The instructions when executed by the processor 111 cause the processor 111 to perform operations discussed herein and below with respect to 113 through 119-1. Cloud 110 also includes a centralized storage repository 119-2 along with interfaces for accessing the repository.

Each distributed developer device 120 includes at least one processor 121 and a medium 122, which includes instructions for a code development system 123. The instructions when executed by the processor 121 cause the processor 121 to perform the operations discussed herein and below with respect to 123.

Each retail server 130 includes at least one processor 131 and a medium 132, which includes instructions for a transaction system 133. The instructions when executed by the processor 131 cause the processor 131 to perform the operations discussed herein and below with respect to 133. Production released microservices 119-1 are processed by and on behalf of each retailer's transaction system 133 to perform retail transactions.

The version control system 113 manages code changes from the distributed developer devices 120, assigning unique commit hashes as identifiers. These commits are stored in the centralized storage repository 119-2 which maintains a comprehensive history of all code modifications including messages describing changes and links to previous commits. In an embodiment, the unique commit hashes are provided by a Git version control system.

The queue manager 114 receives the commits from the version control system 113 and maintains them in a sequential order based on commit time. The queue manager 114 feeds these commits one at a time to the tester and tracker 115 for validation.

The tester and tracker 115 executes predefined test pipelines that are customized for retail microservices against each commit in the testing environment 118. These pipelines specifically validate authentication, payment, loyalty, transaction processing, and fraud detection services through end-to-end testing criteria. The test results, including version information, timestamps, and commit hashes, are stored back in the centralized storage repository 119-2.

The tracer 116 analyzes the test results from the tester and tracker 115 to identify breaking changes and determine the last successful version of each microservice. When breaking changes are detected, the tracer 116 provides this information to the notifier 117, including performance metrics and impact analysis for each commit.

The notifier 117 automatically alerts developers through messaging platforms when breaking changes are identified by the tracer 116. These notifications include detailed commit information such as the unique hash, version number, and description of changes to facilitate rapid issue resolution.

Once code changes pass all tests in the testing environment 118, they can be promoted to the production environment 119 where the microservices 119-1 are deployed. These production-released microservices 119-1 are then utilized by the transaction systems 133 running on the retail servers 130 to process retail transactions.

FIG. 1B is a diagram illustrating sample microservice code changes 100-1 made in a central repository 119-2, according to an embodiment. Commits associated with source code changes to microservices 119-1 ordered by commit time are shown at the top of FIG. 1B. The microservices 119-1 are illustrated as Service 1, Service 2, Service 3, Service 4, and Service 5. The central repository 119-2 stores the versioning information for the commits for the version control system 113.

Each service is shown with four separate commits. For example, Service 1 shows commits 123, 124, and 125; Service 2 shows commits for 345, 346, and 347; service 3 shows commits for 412, 413, and 414. Service 4 shows commits for 775, 776, and 777; and Service 5 shows commits for 092, 093, and 094. The time ordered commits illustrated at the top of FIG. 1B are time commit ordered as 123-775-124-412-345-092-346-347-093 . . . .

FIG. 1C is a diagram illustrating a queue 100-2 for executing testing on sample committed code changes to the central repository 119-2, according to an example embodiment. The top of FIG. 1C illustrates that two commits 123 and 124 are passing testing. The next commit to be tested remains in the queue as commit 124, followed by commit 412, commit 345, and commit 092. The arrow pointing at the bottom of commit 092 is intended to illustrate that as new commits are received, they are pushed into the queue at a tail of the queue. Each commit includes versioning information, data and time, and a unique commit hash value supplied from the version control system 113. For example, commit 124 includes a version number of 2.45.2, a date and time of 2023-11-15 10:38:25 UTC, and a unique hash value of 4485ab3ab2f. This metadata for each commit being tested is retained for each commit.

Next to each commit is also a status indicator. For example, commits 123 and 775 are actively undergoing testing and both their current status show Passing whereas the commits in the queue for commits 124, 412, 345, and 092 show a current status of Status pending.

FIG. 1D is diagram illustrating specific committed code changes 100-3 that first failed testing, according to an example embodiment. The commits are reverse time ordered for illustration, such that commit 092 was a last commit known to have failed testing, followed by commit 345, commit 412, and lastly commit 124; commit 124 was the first in time to have failed testing. Commits 775 and 123 are current passing during testing. Based on this illustration, commits 092, 345, and 412 are likely to have failed because of commit 124.

FIG. 1E is a diagram illustrating a last committed change for a microservice that passed testing before a breaking change was detected for the microservice, according to an example embodiment. As shown in FIG. 1E, Service 5 with commit 092 failed testing, followed by Service 2 with failed commit 345, Service 3 with failed commit 412, and Service 1 with failed commit 124. Service 4 with commit 775 and Service 1 with commit 123 are current passing testing. This illustrates that system 100 quickly identifies for developers the last known working commit as Service 4 with commit 775 before Service 1 commit 124 failed. This allows developers to back out failed commits to the last known passing version and quickly ascertain that commit 124 appears to be the problematic breaking code change in Service 1. This saves developers a tremendous amount of time in locating breaking code changes and pinpointing the specific commit and specific microservice 119-1.

The system 100 provides granular information about breaking changes in an umbrella chart architecture, which is an improvement over traditional approaches that provide multiple service updates simultaneously. This enables developers to quickly identify and resolve issues by pinpointing the exact commit and microservice where a breaking change was introduced.

FIG. 1F is a diagram illustrating a last known status of commits 100-5 as housed in the central repository 119-2, according to an example embodiment. FIG. 1F shows the current status of each microservice 119-1 and each of its corresponding commits as housed in the central repository 119-2. For example, only Service 1 commit 123 is passing testing and Service 4 commit 775. Services 2, 3, and 5 all have failed testing commits.

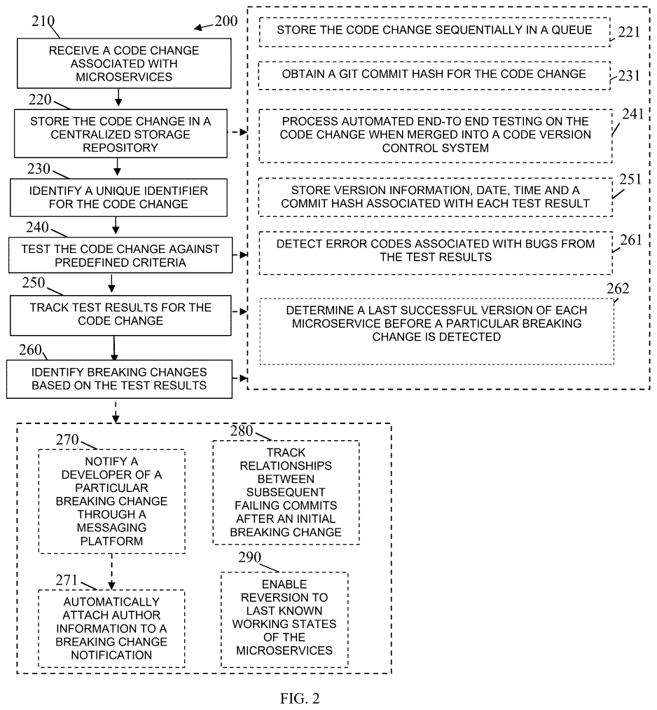

FIG. 2 is a flow diagram of a method 200 for microservice bug tracing, according to an example embodiment. The software module(s) that implements the method 200 is referred to as a “microservice bug tracer.” The microservice bug tracer is implemented as executable instructions programmed and residing within memory and/or a non-transitory computer-readable (processor-readable) storage medium and executed by one or more processors of one or more devices. The processor(s) of the device that executes the microservice bug tracer are specifically configured and programmed to process the microservice bug tracer. The microservice bug tracer may have access to one or more network connections and the connections may be wired, wireless, or a combination of wired and wireless.

In an embodiment, the device that executes microservice bug tracer is cloud 110. In an embodiment, the microservice bug tracer is all or some combination of 113 through 119-2 of cloud 110.

At 210, the microservice bug tracer receives a code changes associated with one or more microservices 119-1. At 220, the microservice bug tracer stores the code change in a centralized storage repository 119-2. In an embodiment, at 221, the microservice bug tracer stores the code change sequentially in a queue.

At 230, the microservice bug tracer identifies a unique identifier for the code change. In an embodiment, at 231, the microservice bug tracer obtains a git commit hash for the code change.

At 240, the microservice bug tracer tests the code change against predefined criteria. In an embodiment, at 241, the microservice bug tracer processes automated end-to-end testing on the code change when merged into a code version control system 113.

At 250, the microservice bug tracer tracks test results for the code change. In an embodiment, at 251, the microservice bug tracer stores version information, date, time, and commit hash associated with each test result.

At 260, the microservice bug tracer identifies at least one breaking change or bug based on the test results. In an embodiment, at 261, the microservice bug tracer detects error codes associated with one or more bugs from the test results. In an embodiment, at 262, the microservice bug tracer determines a last successful version of each microservice before a particular breaking change is detected.

In an embodiment, at 270, the microservice bug tracer notifies a developer of a particular breaking change through a messaging platform. In an embodiment, the messaging platform is Slack® or Teams®. In an embodiment of 270 and at 271, the microservice bug tracer automatically attaches author information to a breaking change notification.

In an embodiment, at 280, the microservice bug tracer tracks relationships between subsequent failing commits after an initial breaking change. In an embodiment, at 290, the microservice bug tracer enables reversion to last known working states of the microservices 119-1.

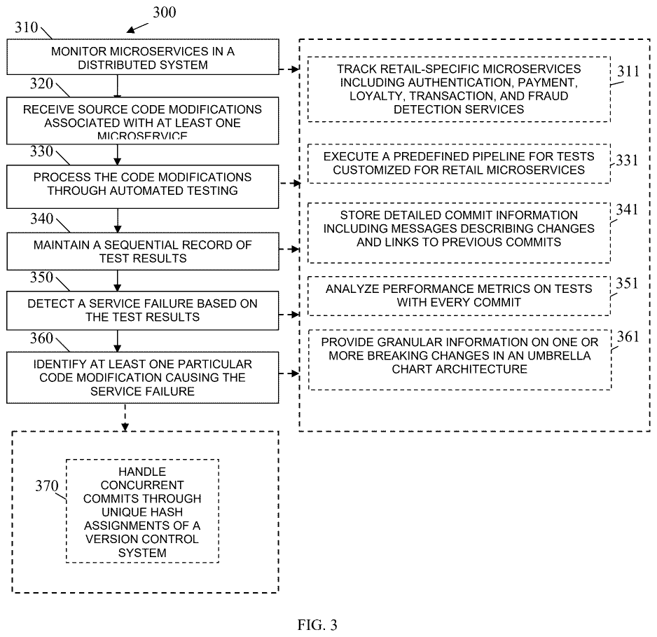

FIG. 3 is a flow diagram of another method 300 for microservice bug tracing, according to an example embodiment. The software module(s) that implements the method 300 is referred to as a “microservice debug assistant.” The microservice debug assistant is implemented as executable instructions programmed and residing within memory and/or a non-transitory computer-readable (processor-readable) storage medium and executed by one or more processors of a device. The processors that execute the microservice debug assistant are specifically configured and programmed for processing the microservice debug assistant. The microservice debug assistant may have access to one or more networks during operation, the networks may be wired, wireless, or a combination of wired and wireless.

In an embodiment, the device that executes microservice debug assistant is cloud 110. In an embodiment, microservice debug assistant is all or some combination of 113 through 119-2, and/or method 200. The microservice debug assistant presents another, and in some ways an enhanced processing perspective from that which was described above with method 200 of FIG. 2.

At 310, the microservice debug assistant monitors microservices 119-1 in a distributed system. In an embodiment, at 311, the microservice debug assistant tracks retail-specific microservices including authentication services, payment services, loyalty services, transaction services, and fraud detection services that are critical for processing retail transactions.

At 320, the microservice debug assistant receives source code modification associated with at least one microservices 119-1. At 330, the microservice debug assistant processes the source code modifications through automated testing. In an embodiment, at 331, the microservice debug assistant executes a predefined pipeline for tests customized for retail microservices.

At 340, the microservice debug assistant maintains a sequential record of test results. In an embodiment, at 341, the microservice debug assistant stores detailed commit information including messages describing changes and links to previous commits.

At 350, the microservice debug assistant detects a service failure based on the test results. In an embodiment, at 351, the microservice debug assistant analyzes performance metrics on tests with every commit.

At 360, the microservice debug assistant identifies at least one particular code modification causing the service failure. In an embodiment, at 361, the microservice debug assistant provides granular information on one or more breaking changes in an umbrella chart architecture.

In an embodiment, at 370, the microservice debug assistant handles concurrent commits through unique hash assignments of a version control system 113. In an embodiment, the version control system 113 is Git version control system.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a code change associated with one or more microservices;
storing the code change in a centralized storage repository;
identifying a unique identifier for the code change;
testing the code change against predefined validation criteria;
tracking test results for the code change; and
identifying one or more breaking changes based on the test results.

2. The method of claim 1, wherein storing the code change comprises storing the code change sequentially in a queue.

3. The method of claim 1, wherein identifying the unique identifier comprise obtaining a Git commit hash for the code change.

4. The method of claim 1, wherein testing the code change comprises processing automated end-to-end testing on the code change when merged into a code version control system.

5. The method of claim 1, wherein tracking the test results comprises storing version information, date, time, and a commit hash associated with each test result.

6. The method of claim 1, wherein identifying the one or more breaking changes comprises detecting error codes associated with bugs from the test results.

7. The method of claim 1, wherein identifying the one or more breaking changes comprises determining a last successful version of each microservice before a particular breaking change.

8. The method of claim 1, further comprising notifying a developer of a particular breaking change through a messaging platform.

9. The method of claim 8, wherein notifying the developer comprises automatically attaching author information to a breaking change notification.

10. The method of claim 1, further comprising tracking one or more relationships between subsequent failing commits after an initial breaking change.

11. The method of claim 1, further comprising enabling reversion to one or more last known working states of the one or more microservices.

12. A method, comprising:
monitoring microservices in a distributed system;
receiving a plurality of source code modifications associated with at least one microservice;
processing the plurality of source code modifications through automated testing;
maintaining a sequential record of test results;
detecting a service failure based on the test results; and
identifying at least one particular specific code modification causing the service failure.

13. The method of claim 12, wherein monitoring comprises tracking retail-specific microservices including authentication, payment, loyalty, transaction, and fraud detection services.

14. The method of claim 12, wherein processing comprises executing a predefined pipeline of tests customized for retail microservices.

15. The method of claim 12, wherein maintaining comprises storing detailed commit information including messages describing changes and links to previous commits.

16. The method of claim 12, wherein detecting comprises analyzing performance impacts on tests with every commit.

17. The method of claim 12, wherein identifying comprises providing granular information about one or more breaking changes in an umbrella chart architecture.

18. The method of claim 12, further comprising handling concurrent commits through unique hash assignments of a version control system.

19. A system, comprising:
a centralized storage repository configured to store a plurality of source code changes for microservices;
a testing environment configured to validate the plurality of source code changes;
a tracker configured to maintain test results; and
a notifier configured to at least one alert developer of at least one breaking change associated with the plurality of source code changes to the microservices.

20. The system of claim 19, wherein the centralized storage repository comprises a queue configured to process the plurality of source code changes sequentially within the testing environment.
